(19) United States
(12) Patent Application Publication
(10) Pub. No.: US 2008/0102309 A1
(43) Pub. Date: May 1, 2008

(54) HEATING ELEMENT SHEATHS

(76) Inventors: Charles D. Tuffile, Dighton, MA (US); Clive Britton, Victoria (AU)

Correspondence Address: PEARNE & GORDON LLP, 1801 EAST 9TH STREET, SUITE 1200, CLEVELAND, OH, 44114-3108, US

(21) Appl. No.: 11/877,193

(22) Filed: Oct. 23, 2007

Related U.S. Application Data
(60) Provisional application No. 60/863,184, filed on Oct. 27, 2006.

(51) Int. Cl. B32B 15/18; B23K 20/12; H01B 7/16

(52) U.S. Cl. 428/679; 228/117; 428/373; 428/685

(57) ABSTRACT

The present invention is directed to a nickel-based alloy, such as INCOLOY or INCONEL, clad stainless steel sheath tubing material for heating elements. This clad material is designed to minimize the cost of heating elements generally constructed entirely of nickel-based alloys alone while providing necessary material requirements of weldability, hot strength, corrosion resistance, thermal shock resistance, and formability.

### CROSS-REFERENCE TO RELATED APPLICATION

This application claims the benefit of U.S. Provisional Application No. 60/863,184 filed on Oct. 27, 2006, which is incorporated herein by reference in its entirety.

### FIELD OF INVENTION

The present invention relates to heating elements and, in particular, tubular heating element sheaths. More specifically, the present invention is directed to a nickel-based alloy, such as INCOLOY or INCONEL, clad stainless steel sheath tubing material for heating elements. This clad material is designed to minimize the cost of heating elements generally constructed entirely of nickel-based alloys alone while providing necessary material requirements of weldability, hot strength, corrosion resistance, thermal shock resistance, and formability.

### BACKGROUND INFORMATION

The tubular electric heating element, known by trade names such as Calrod or Corox, was patented in 1925 by General Electric Company in U.S. Pat. No. 1,547,837 (incorporated herein by reference). Since then, a variety of tubular electric heating elements have been developed and are used today in a number of domestic appliance applications including, but not limited to, cooktop heating elements, grilling elements, oven elements, dishwasher elements, hot water or oil immersion heating elements, microwave elements, and toaster oven elements.

In general, a modern tubular heating element is comprised of an electrical resistance wire coil or helix embedded in a compacted media of magnesium oxide which is contained in a welded tubular metal sheath. If the sheath is visually exposed, i.e. can be seen, it is usually constructed of a nickel-based alloy such as INCOLOY or INCONEL. However, if the heating element is not visually exposed, the sheath can be made of stainless steel, steel, copper or aluminum. Rod or wire terminal pins to which the ends of the resistance helix have been welded, protrude from each end for electrical connection.

Material selection for the sheath tubing is dependent on the function of the device. Copper is widely used for water heaters. For flat irons, or other appliances where heating elements are embedded into cast metal, the elements are frequently steel or Bundy weld tubing. However, for higher temperatures, or where the element is exposed, the specified sheath material is typically a nickel-based alloy such as one of the series of INCOLOY or INCONEL. The cost of the nickel-based alloys is significantly higher than the other sheath materials due to the nickel-based content in the alloys.

In view of the foregoing, it would be desirable to be able to continue to take advantage of the benefits of using a nickel-based alloy material, such as INCONEL or INCOLOY, in the tubular sheaths of heating elements while reducing the costs associated with using those materials exclusively.

### SUMMARY OF THE INVENTION

In accordance with the present invention, a sheath for a heating element is provided which comprises a tubular sheath wherein the sheath is comprised of a stainless steel layer which has a nickel-based alloy layer clad to a surface thereof is provided. According to one embodiment, the outer surface of a tubular stainless steel sheath for a heating element is clad with a layer of nickel-based alloy.

A further embodiment of the invention is directed to a heating element sheath wherein the sheath is comprised of a stainless steel layer which has a nickel-based alloy layer clad to a surface thereof wherein the nickel-based alloy comprises nickel, chromium, and iron. In a further aspect, the nickel alloy has a nickel content of from about 18% to about 72% and a chromium content of from about 14% to about 23%. In a further aspect, nickel-based alloys, such as INCONEL and INCOLOY, are exemplary of nickel-based alloys which contain nickel and chromium.

A further aspect of the invention includes a heating element comprising an electrical resistance wire, an insulating layer and an outer tubular sheath wherein the outer tubular sheath has an inner stainless steel layer and an outer nickel-based alloy layer clad to the stainless steel layer. According to one aspect of the invention, the inner stainless steel layer can have a thickness of from about 30% to about 95% of the total strip thickness. In another aspect, the outer nickel-based alloy layer can have a thickness of from about 5% to about 70% of the total strip thickness.

An additional aspect of the invention is directed to a process for making a nickel-based alloy clad stainless steel material having a nickel-based alloy layer and a stainless steel layer comprising roll bonding a nickel-based alloy material to a stainless steel material such that a metallurgical bond is formed between the nickel-based alloy layer and the stainless steel layer.

These and other aspects and objects of the invention will become apparent upon reading and understanding the full description of the invention as well as from practicing the invention according to the description set forth herein.

### BRIEF DESCRIPTION OF THE DRAWINGS

FIG. 1 shows an embodiment of a section of a heating element according to the invention.

FIG. 2 shows a cross-section view along line 2-2 of an embodiment of a heating element according to the invention.

### DETAILED DESCRIPTION OF THE INVENTION

The present invention is directed to a nickel-based alloy, such as INCOLOY or INCONEL, clad stainless steel sheath tubing material for heating elements. This clad material is designed to minimize the cost of heating elements generally constructed entirely of nickel-based alloys alone while providing necessary material requirements of weld-ability, hot strength, corrosion resistance, thermal shock resistance, and formability.

According to the present invention, various types of stainless steel (particularly 300 series austenitic types) are suitable for using as the base material for tubular sheaths used in heating elements due to the relatively inexpensive cost of stainless steel along with the desirable material properties (such as corrosion resistance, hot strength, and weld-ability) that stainless steel possesses, which would only otherwise be obtained with materials that are significantly more expensive than stainless steel. Since the tube produced with the clad material needs to be seam welded, the weld chemistry is important. The primary constituents of austenitic stainless steel alloys, such as UNS S30400, are iron, chromium, and nickel, as are also the primary constituents of INCOLOY and INCONEL alloys, which ultimately results in relatively high Ni and Cr contents in the weld zone after the dilution of the stainless steel and nickel-based alloys. The entire surface of the seam-welded tube, including the weld, must develop a continuous black oxide in a post welding heat treatment to impart the necessary corrosion resistance and aesthetics. The development of the black oxide is highly dependant on the Ni and Cr content of the stainless steel and Ni alloy.

According to the present invention, the nickel alloy has a nickel content of from about 18% to about 72% and a chromium content of from about 14% to about 23%. Nickel-based alloys, such as INCONEL and INCOLOY, are exemplary of nickel-based alloys which contain nickel and chromium. The stainless steel is typically a stainless steel which has a composition that is similar to that of the nickel alloy. Austenitic stainless steel materials such as UNS S30100, S30200, S30400, S30500, S30900, S31600, S32100, and S34700 are exemplary of the types of stainless steel materials useable in the invention. The stainless steel layer can have a thickness of from about 30% to about 95% of the total strip thickness. In another aspect, the outer nickel layer can have a thickness of from about 5% to about 70% of the total strip thickness.

The nickel-based alloys can be metallurgically bonded to the stainless steel layer via roll bonding such as, for example, cold roll bonding which results in a true metallurgical bond, with no adhesive or binder, between the materials. Roll bonding allows a relatively thick layer of nickel-based alloy, such as INCOLOY or INCONEL alloy, to be bonded to the stainless steel, which is necessary for the material to meet the hot strength and corrosion requirements. After bonding, the clad metal can be processed using conventional metal working processes such as rolling, annealing, and slitting to yield a product that has sufficient formability and meets the hot strength requirements. A roll bonding process which can be used with the present invention can be found in, for example, U.S. Pat. No. 5,553,770, incorporated herein by reference.

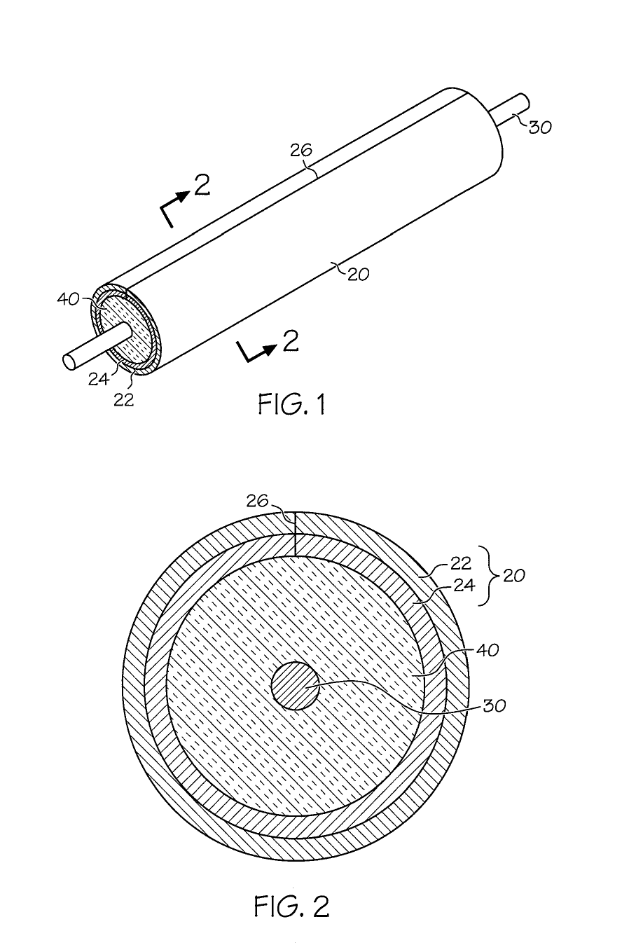

The more expensive, nickel-based alloy, such as INCOLOY or INCONEL alloy, is present on at least the outside of the tubular electric heating element to provide corrosion resistance, hot strength, and an aesthetically pleasing uniform black oxide. By cladding the nickel-based alloys to a stainless steel, and forming the sheath such that the nickel-based alloy is on the outside of the tube, the attractive properties of the expensive nickel-based alloys are positioned appropriately for performance, while the stainless steel component provides strength and acts to reduce the material cost (FIGS. 1 and 2). However, it is to be understood that the invention could equally well be practiced with a stainless steel layer being bonded on both top and bottom with nickel-based alloy layers forming a composite multilayer material.

A heating element according to the invention is depicted (as a cut away) in FIG. 1. As shown in FIG. 1, the heating element comprises a tubular sheath (20), an electrical resistance wire (30) and an insulation layer (40) disposed between an inner surface of the tubular sheath (20) and the electrical resistance wire (30). FIG. 2 is a cross section of the heating element of FIG. 1 along line 2-2. As shown in both FIGS. 1 and 2, the tubular sheath (20) is comprised of an inner layer (24) and an outer layer (22). According to one embodiment of the invention, the inner layer (24) of the tubular sheath is a stainless steel material and the outer layer (22) is a nickel-based alloy material.

The outer nickel-based alloy layer (22) can be metallurgically bonded to the stainless steel (24) layer via roll bonding such as, for example, cold roll bonding which results in a true metallurgical bond, with no adhesive or binder, between the materials. The materials are bonded together as flat sheets to form a nickel-based alloy clad stainless steel sheet. These sheets can then be cut into strips and formed into a tubular shape by welding along the seam (26) as shown in FIGS. 1 and 2. As mentioned previously, since the tube produced with the clad material needs to be seam welded, the weld chemistry is important. The primary constituents of austenitic stainless steel alloys, such as UNS S30400, are iron, chromium, and nickel, as are also the primary constituents of INCOLOY and INCONEL alloys, which ultimately results in relatively high Ni and Cr contents in the weld zone after the dilution of the stainless steel and Ni alloys.

By utilizing the clad sheet material of the invention, the percent reduction in the use of nickel-based alloy can be from about 30% to as much as 95% compared to using a tubular sheath constructed entirely of a nickel-based alloy such as INCONEL or INCOLOY wherein the nickel-based alloy is substituted with stainless steel.

The nickel-based, alloy clad stainless steel sheaths in the present invention provide a less expensive, yet functionally equivalent alternative to heating element sheaths made entirely of nickel-based alloys such as:

INCOLOY alloy 800 (UNS N08800)—32/20 Ni/Cr

INCOLOY alloy 840 (UNS S33400)—20/20 Ni/Cr

INCOLOY alloy 825 (UNS N08825)—42/20 Ni/Cr

INCONEL alloy 600 (UNS N06600)—72/15 Ni/Cr

Any of the aforementioned nickel-based alloys can be used as the nickel-based alloy clad material for the nickel-based alloy clad stainless steel sheath of the present invention. INCOLOY or INCONEL clad stainless steel is a significantly lower cost alternative to straight INCOLOY or INCONEL alloy strip. The savings is due to the replacement of a portion of the expensive INCOLOY or INCONEL with a lower cost stainless steel.

The clad materials of the invention comprise a volume ratio of nickel based alloy/stainless steel of from about 5/95 to 70/30, preferably 20/80 to 40/60.

To illustrate an advantage of the material of the invention, using a 20/80 volume ratio of INCOLOY alloy 840/UNS S30403, the total material system contains 10.4% Ni versus 20% Ni in the straight INCOLOY alloy 840 strip.

The following examples are provided to more fully illustrate the invention and are in no way intended to limit the scope of the invention.

### EXAMPLE I

In this example, the layer ratio of INCOLOY alloy 840 to S30403 was 20/80 in the bonded material. The material for this example was fabricated using cold roll bonding. The raw materials prior to bonding, INCOLOY alloy 840 and S30403, were 0.012″ and 0.045″ thick respectively. The raw materials were cold roll bonded to a total clad thickness of 0.0170″, where the INCOLOY alloy 840 layer was 0.0034″ thick and the S30403 layer was 0.0136″ thick. The bonded material was then annealed at 1900° F. (˜1038° C.) to improve the bond strength and anneal both of the components of the bonded material. Following bonding, the material was slit to the required width to form seam welded tubes of a specified diameter. The mechanical properties of the material produced by this example are shown in Table 1 below.

TABLE 1

| | |
|---|---|
| Gauge | 0.0170″ |
| Tensile Strength | 91.2 ksi |
| Yield Strength | 36.6 ksi |
| Percent Elongation | 53.3% |
| Microhardness (INCOLOY alloy 840 layer) | 134 DPH |
| Microhardness (S30403 layer) | 150 DPH |
| ASTM Grain Size (INCOLOY alloy 840 layer) | 9.5 |
| ASTM Grain Size (S30403 layer) | 9.0 |

### EXAMPLE II

In this example, the layer ratio of INCOLOY alloy 840 to S30403 was 32/68 in the bonded material. The raw materials prior to bonding, INCOLOY alloy 840 and S30403, were 0.0136″ and 0.0290″ thick respectively. The raw materials were cold roll bonded to a total clad thickness of 0.0170″, where the INCOLOY alloy 840 layer was 0.0054″ thick and the S30403 layer was 0.0116″ thick. The bonded material was then annealed at 1900° F. (˜1038° C.) to improve the bond strength and anneal both of the components of the bonded material. Following bonding, the material was slit to the required width to form seam welded tubes of a specified diameter. The mechanical properties for the 32/68 ratio material measured:

TABLE 2

| | |
|---|---|
| Gauge | 0.0170″ |
| Tensile Strength | 86.6 ksi |
| Yield Strength | 35.0 ksi |
| Percent Elongation | 53.1% |
| Microhardness (INCOLOY alloy 840 layer) | 141 DPH |
| Microhardness (S30403 layer) | 149 DPH |
| ASTM Grain Size (INCOLOY alloy 840 layer) | 9.5 |
| ASTM Grain Size (S30403 layer) | 9.0 |

### EXAMPLE III

In this example, the layer ratio of INCOLOY alloy 840 to S30403 was 40/60 in the bonded material. The raw materials prior to bonding, INCOLOY alloy 840 and S30403, were 0.0170″ and 0.0255″ thick respectively. The raw materials were cold roll bonded to a total clad thickness of 0.0170″, where the INCOLOY alloy 840 layer was 0.0068″ thick and the S30403 layer was 0.0102″ thick. The bonded material was then annealed at 1900° F. (˜1038° C.) to improve the bond strength and anneal both of the components of the bonded material. Following bonding, the material was slit to the required width to form seam welded tubes of a specified diameter. The mechanical properties for the 40/60 ratio material measured:

TABLE 3

| | |
|---|---|
| Gauge | 0.0170″ |
| Tensile Strength | 92.4 ksi |
| Yield Strength | 37.4 ksi |
| Percent Elongation | 49.5% |
| Microhardness (INCOLOY alloy 840 layer) | 126 DPH |
| Microhardness (S30403 layer) | 148 DPH |
| ASTM Grain Size (INCOLOY alloy 840 layer) | 8.5 |
| ASTM Grain Size (S30403 layer) | 9.5 |

The difference of this invention from the prior art is the use of a clad material versus a monolithic alloy as the sheath material. By cladding the nickel-based alloy, such as INCOLOY or INCONEL, to stainless steel the overall cost of heating elements can be dramatically reduced compared to an element wherein the entire tubular sheath is made from nickel-based alloy material while still providing the necessary and beneficial material properties for the application in heating elements.

The invention has been described hereinabove using specific examples. However, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A heating element comprising a tubular sheath wherein the sheath is comprised of a stainless steel layer which has a nickel-based alloy layer clad to a surface thereof.

2. The heating element of claim 1 wherein the nickel-based alloy comprises nickel and chromium.

3. The heating element of claim 2 wherein the nickel-based alloy is an INCOLOY or INCONEL alloy.

4. The heating element of claim 3 wherein the nickel-based alloy is selected from INCOLOY alloy 800, 825, 840 or INCONEL alloy 600.

5. The heating element of claim 2 wherein the nickel-based alloy comprises from about 18% to about 72% nickel.

6. The heating element of claim 2 wherein the nickel-based alloy comprises from about 14% to about 23% chromium.

7. The heating element of claim 2 wherein the nickel-based alloy comprises from about 18% to about 72% nickel and from about 14% to about 23% chromium.

8. The heating element of claim 1 wherein the nickel-based alloy layer is on an outer surface of the tubular sheath.

9. The heating element of claim 8 wherein the nickel-based alloy layer has a thickness of from about 5% to about 70% of the total strip thickness.

10. The heating element of claim 9 wherein the stainless steel layer has a thickness of from about 30% to about 95% of the total strip thickness.

11. The heating element of claim 1 wherein the volume ratio of nickel-based alloy to stainless steel is from about 5/95 to about 70/30.

12. A heating element comprising an electrical resistance wire, an insulating layer and an outer tubular sheath wherein the outer tubular sheath has an inner stainless steel layer and an outer nickel-based alloy layer clad to the stainless steel layer.

13. The heating element of claim 12 wherein the nickel-based alloy comprises nickel and chromium.

14. The heating element of claim 13 wherein the nickel-based alloy is an INCOLOY or INCONEL alloy.

15. The heating element of claim 14 wherein the nickel alloy is selected from INCOLOY alloy 800, 825, 840 or INCONEL alloy 600.

16. The heating element of claim 13 wherein the nickel alloy comprises from about 18% to about 72% nickel.

17. The heating element of claim 13 wherein the nickel alloy comprises from about 14% to about 23% chromium.

18. The heating element of claim 13 wherein the nickel alloy comprises from about 18% to about 72% nickel and from about 14% to about 23% chromium.

19. A process for making a nickel-based alloy clad stainless steel material having a nickel-based alloy layer and a stainless steel layer comprising roll bonding a nickel-based alloy material to a stainless steel material such that a metallurgical bond is formed between the nickel-based alloy layer and the stainless steel layer.

20. The process of claim 19 wherein the ratio of nickel-based alloy material to stainless steel material is from about 5/95 to about 70/30.

21. The process of claim 19 wherein the nickel-based alloy material comprises nickel and chromium.

22. The process of claim 20 wherein the nickel-based alloy is an INCOLOY or INCONEL alloy.

23. The process of claim 19 wherein the nickel-based alloy clad stainless steel material is roll bonded to a thickness of from about 0.015 inches to about 0.030 inches.

24. The process of claim 23 wherein the nickel-based alloy layer has a thickness of from about 5% to about 70% of the total strip thickness.

25. The process of claim 23 wherein the stainless steel layer has a thickness of from about 30% to about 95% of the total strip thickness.
